(19) United States
(12) Patent Application Publication
(10) Pub. No.: US 2008/0162312 A1
(43) Pub. Date: Jul. 3, 2008

(54) METHOD AND SYSTEM FOR MONITORING SECURE APPLET EVENTS DURING CONTACTLESS RFID/NFC COMMUNICATION

(75) Inventors: VLADIMIR SKLOVSKY, VERNON HILLS, IL (US); RUBEN R. FORMOSO, WESTON, FL (US); LYLE A. GAASTRA, HAINESVILLE, IL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/618,163

(22) Filed: Dec. 29, 2006

(51) Int. Cl. G06Q 40/00; G06Q 10/00

(52) U.S. Cl. 705/35; 705/1

(57) ABSTRACT

A system (211) and method (400) for reliable monitoring of secure applet events is provided. The system can include a Near Field Communication (NFC) modem (140) for communicating transaction events, a secure controller (200) for monitoring state transitions caused by the transaction events, and a mobile host (125) for receiving event notifications of the state transitions via an Applications Programming Interface. An NFC reader can send a Transaction Acknowledgement TACK (403) to the NFC modem to confirm a receipt of data associated with an applet event. An INFO message (405) can be included with the TACK for informing a user of secure contactless transaction status through a user interface (190) of the mobile host.

### RELATED APPLICATIONS

U.S. Patent Application, filed Dec. 29, 2006, by Sklovsky et al., entitled “Method and System for Monitoring Secure Application Execution Events During Contactless RFID/NFC Communication”, attorney docket No. CS29539RL_Sklovsky (7463-291), incorporated herein by reference in its entirety.

### FIELD OF THE INVENTION

The present invention relates to mobile devices, and more particularly, to contactless transactions using a mobile device.

### INTRODUCTION

The use of portable electronic devices and mobile communication devices has increased dramatically in recent years. Moreover, the demand for mobile devices that allow users to conduct contactless transactions is increasing. Near Field Communication technology (NFC) enables mobile devices to act as an electronic data transaction device. As one example, NFC can be used to perform contactless financial transactions such as those requiring a credit card. The user may select credit card information stored in the mobile device and perform contactless payments in a quick way by “tapping” or “waving” the mobile device in front of a contactless reader terminal. A reader terminal can read the credit card information and process a financial transaction. In practice, NFC can be coupled with a secure module to provide contactless payment transactions. The secure module can provide secure credit card information to the reader terminal using the NFC technology.

A contactless transaction ends when the credit card information, or other information, has been successfully read by the reader terminal. For example, the transaction ends successfully if the entire credit card information stored into the NFC-SM has been successfully read. However, during contactless payment transactions, it is not always guaranteed that a reader terminal will successfully read the credit card information. The contactless transaction may fail if only part of the credit card information has been read. It should also be noted, that once the reader has read the credit card information, an entity associated with the reader, such as a banking system, may accept or reject the contactless transaction. For instance, a banking system may reject the transaction if the balance of the account is insufficient for the payment even though the reading of the credit card information was technically successful. Whereas a banking transaction may fail when there is not enough money on the account, the mobile device transaction for providing the credit card information may succeed if the credit card information is read successfully.

Due to security restriction requirements, the mobile device is not authorized to evaluate secure transactions between the secure module and the reader terminal. That is, the mobile device is insulated from secure transactions occurring between the secure module and the reader terminal, even though the secure module is on the mobile device. Accordingly, a user of the mobile device may not have any means of knowing whether the credit card, or other secure data, was successfully read. In current NFC secure module technology, the mobile device can only monitor radio frequency (RF) events between the mobile device and the reader. To determine if a credit card has been successfully read, in the NFC-SM or in any other embedded secured module, the mobile device must analyze RF signals and determine what happened during the contactless transaction based only on an assessment of the RF signals. However, monitoring RF signals alone does not allow the mobile device to accurately inform the user for end of transaction events.

For example, referring to FIG. 1, a system of the prior art for NFC is shown. The system 100 can include an integrated circuit 110 and a reader terminal 170 for processing contactless transactions. The integrated circuit 110 can include an antenna for communicating passive or active RF signals within an RF field 150 of the reader terminal 170. In one arrangement, the reader terminal 170 may be a payment terminal for conducting financial transactions such as reading credit information from the mobile device 110. The integrated circuit 110 can include an application processor 120 for providing a user interface for the contactless transactions, a NFC-SM 130 that informs the application processor 120 of secure transactions and that provides secure credit card information, and a NFC modem 140 for communicating the credit card information to the reader terminal 170.

As per existing banking standards, virtual payment cards can be used with the NFC secure module to conduct the contactless payment transaction with the reader terminal 170. The virtual payment cards can be JavaCard applications or other smart card applications loaded and installed in the NFC-secure module 130. These contactless applications hold the same data as the one in a contact or contactless credit card, such as Cardholder information data, Cryptographic keys, Cardholder authentication procedures (personal identification numbers, biometrics, etc) The payment applications may be JavaCard™ applets. For instance a bank or credit card agency may provide a card solution that consists in two JavaCard applets that are the PayPass™ Payment System Environment (PPSE) and PayPass™ contactless payment applets. These JavaCard applications are provided either by the bank or credit card agencies and installed in the NFC-SM 130.

In a contactless payment scenario, data exchange between the reader terminal (payment terminal) 170 and the NFC-SM 130 can be performed over-the-air using a NFC protocol. The NFC controller 130 acts as a real contactless card and handles all external requests from the reader terminal 170 itself through the NFC modem 140 over communication link 3 (132). The link 3 (132) is defined by the card manufacturer and may be a proprietary one such as a Single Wire Protocol implementation or a standardized one such as a Multi Media Card implementation. Any data exchange between the application processor 120 and the NFC controller 130 is performed through the physical line link 1 (122). The communication link 122 may be one as defined in ISO 7816 standards. Any data exchange between the application processor 120 and the NFC modem 140 is done through the communication link 2 (160). The communication link 160 is typically involved during the NFC payment application initialization and termination phase to manage the NFC modem 140 resource. The communication link 160 is used to monitor RF events at the NFC modem side, and may be based on proprietary protocols such as I²C or UART.

In particular, as shown in FIG. 1, the application processor 120 can only communicate with the NFC modem 140 over Link 2 160. Link 2 160 only provides for monitoring of RF events on the side of the integrated circuit 110. That is, the Link 2 does not provide any information as to whether the reader 170 successfully read or processed contactless transactions with the NFC-controller 130. In such regard, the application processor 120 cannot confirm whether the reader 170 completed the contactless transaction, nor monitor end of transaction events directly between the NFC controller 130 and the NFC modem 140. Due to security restrictions, the application processor 120 cannot access transaction information in the NFC controller 130. Only RF events in the RF field 150 can be monitored by the application processor 120. Monitoring RF events in the RF field 150 does not provide a true indication for an end of transaction event due to peculiarities of movement between the mobile device and the reader terminal.

As an example, variations in RF field 150 strength as a result of intensity changes in the neighborhood of the reader terminal 170 can produce false end of transactions. For example, the user may move the mobile device 110 too rapidly in the RF field 150, or insufficiently close to the reader terminal 170. The RF field might be cut off due to weak signal strength, signal degradations, improper distance from the reader, or the security issues. In such cases, the RF events cannot be reliably monitored through RF field detection. Moreover, the RF field 150 can be payment terminal-dependent such that the end of transaction notification on the mobile device 110 may vary from one terminal to another. Some terminals may not switch off their RF field 150 at the end of the transaction. Furthermore, in the current implementation of NFC-SM as shown in FIG. 1, monitoring the RF field 150 may require switching the NFC communication link 3 (132) configuration between the NFC modem 140 and the NFC-SM secured module 130 on the mobile device 110 which may reset any pending payment transaction.

### SUMMARY

Broadly stated, embodiments of the invention are directed to a system and method for monitoring secure contactless transaction events in a mobile device. One embodiment is directed to a system for secure contactless transaction suitable for use in a mobile device. The system can include a Near Field Communication (NFC) modem for communicating transaction events with a NFC reader, a secure controller (SC) for reliable monitoring of secure applet events associated with the transaction events, and a mobile host communicatively coupled to the secure controller for receiving event notifications from the secure applet events via an Applications Programming Interface. The mobile device can present a user interface to display the event notifications.

The secure controller exposes a messaging Applications Programming Interface (API). The secure controller implements the underlying hardware to enable messaging mechanisms, and the software to access the underlying hardware mechanisms. This allows an application running on a mobile host to access a secure applet and receive notification of event occurrences concerning the secure contactless transaction. In one arrangement, the secure controller can indicate a completion of data transaction upon detecting state transitions caused by events execution. The secure controller can notify the mobile host of the completion of data transaction. In another arrangement, the NFC reader can send a Transaction Acknowledgement (TACK) to the NFC modem to confirm a receipt of data associated with the secure contactless transaction. Moreover, the NFC reader can also send an INFO message with the TACK to provide additional information associated with the secure contactless transaction. The additional information can identify a logo of a card issuer, a credit card brand, an application identifier, that can be displayed on the mobile host. The additional information can also include ticketing information, cash card information, access control information, or set-up data to automatically launch an application.

The secure controller can include a RFID/NFC communication interface to the NFC modem for communicating transaction events, a data manager operatively coupled to the RFID/NFC communication interface for signaling transaction event occurrences and handling transaction event data, and a communication interface (CIF) operatively coupled to the data manager for conveying messages to the mobile host in response to transaction event occurrences. The data manager can include a secure protected memory for storing data and transaction events communicated between the NFC modem and the NFC reader, and a mailbox for retrieving the data and transaction events and providing reliable event notifications to the CIF. The mailbox can include a timer for identifying transaction event times, an events status register (ERB) for specifying a number of transaction events and a status of the transaction events, and at least one data register for identifying data and transaction events in the secure protected memory. The data manager can set up a Transaction Complete Flag (TCF) in the ESR to indicate a completion of a secure contactless transaction that can be exposed through the API. The mailbox can be shared between the mobile host and the secure controller through the API. The secure controller can also include a queue line of monitored events and a NFC RF stack for buffering applet events.

One embodiment is directed to a method for secure contactless transaction. The method can include monitoring event executions of a secure applet during a secure contactless transaction, detecting applet state transitions caused by the event executions, and notifying an application of the applet state transitions upon an event occurrence by a software-based Applications Programming Interface (API) messaging mechanism that includes supported hardware and software. The method expose an API from an underlying hardware implementation. That is, the API builds on top of the underlying hardware implementation to provide applet event notification and messaging. The underlying hardware implementation can include generating a hardware interrupt by setting a flag in an events status register (ERB) of a mailbox upon detecting the last state transition. This allows the secure controller to communicate a message to the mobile host via a timer-based Applications Programming Interface (API).

Additional information can also be received during the secure contactless transaction. The additional information can be saved to a secure protected memory in a mailbox. The mailbox can be shared between an operating system of the mobile host and the secure controller. During secure contactless transactions, a message can be sent to inform the application that the additional information in the mailbox is available for reading. The method can further include sending a transaction acknowledgement (TACK) from the NFC reader to the NFC modem to confirm a receipt of data at the NFC reader, and receiving the TACK at the NFC modem. The TACK can confirm a complete receiving of the data associated with the secure contactless transaction. Additional information can be received with the TACK and presented through a user interface.

Another embodiment is directed to an electronic wallet for secure contactless transactions. The electronic wallet can include a NFC/RFID modem for sending and receiving RF signals of a secure contactless transaction, a secure controller communicatively coupled to the NFC/RFID modem for identifying events associated with the secure contactless transaction based on a software mechanism, and a mobile host for receiving a status of the events from the secure controller, the mobile host presenting the status and the events through a user interface. In one arrangement, the NFC/RFID modem can send a transmit acknowledgement (TACK) to confirm that data associated with completing the secure contactless transaction was received. The mobile host can display information associated with a completion of the secure contactless transaction. The secure controller can be compatible with a smart card operating system. The secure controller can notify the mobile host of secure contactless transactions in view of state transitions, and the mobile host can display information associated with the secure contactless transaction. In one arrangement, the NFC/RFID modem can send a transmit acknowledgement (TACK) to confirm that data associated with completing the secure contactless transaction was received. The mobile host can display information associated with a completion of the secure contactless transaction.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a Near Field Communication (NFC) Controller of the prior art for secure contactless transactions in accordance with the embodiments of the invention;

FIG. 2 is a general block diagram for a NFC/RFID secure contactless transaction system in accordance with the embodiments of the invention;

FIG. 3 is a diagram for monitoring NFC applet execution in accordance with the embodiments of the invention;

FIG. 4 is a more detailed block diagram of the secure controller for the NFC/RFID secure contactless transaction system of FIG. 2 in accordance with the embodiments of the invention;

FIG. 5 is a method for detecting a completion of secure contactless transaction using a transaction acknowledgement (TACK) in accordance with the embodiments of the invention;

FIG. 6 is a depiction of using a TACK for identifying a completion of secure contactless transaction in accordance with the embodiments of the invention;

FIG. 7 is a method for implementing a software or hardware transaction acknowledgement (TACK) in accordance with the embodiments of the invention;

FIG. 8 is a method for including additional information (INFO) with a TACK in accordance with the embodiments of the invention;

FIG. 9 is an illustration for including additional information (INFO) with a TACK in accordance with the embodiments of the invention; and

FIG. 10 is a flowchart for NFC/RFID contactless transaction based on state transitions and a TACK command in accordance with the embodiments of the invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The term “transaction event” can be defined as an event occurring between a NFC modem and a NFC reader, the event occurring through radio frequency communication. The term “applet event” can be defined as an event occurring on a secure controller that is associated with a transaction event. The term “state transition” can be defined as a change in states of an applet that is running on a secure controller. The term “application” can be defined as a process running on a mobile host. The term “mobile host” can be defined as a processor or a mobile device. The term “messaging mechanism” can be defined as hardware or software that provides an exchange of data. The term “completed transaction” can be defined as one stage of completion of a secure contactless transaction, or as a final completion of the secure contactless transaction. The term “events execution” can be defined as the execution of transaction events or applet events.

Broadly stated, embodiments of the invention are directed to monitoring event transactions. The monitoring can be based on applet state transitions which are generated by in response to an execution of events between an NFC modem and a NFC reader. In one arrangement, a secure applet can notify a mobile host of an event occurrence through a software based messaging mechanism. The messaging mechanism can be a software Applications Programming Interface (API) that interfaces to an underlying hardware implementation. In one arrangement, the mobile host, which does not always have access to secure controller (TD) events during secure applet execution, can be informed of the events via the software messaging mechanism using the Applications Programming Interface (API). The messages can be delivered to the host after all data processing and data transaction has been completed at the NFC Reader. In this case, upon the completion of data transaction, the mobile host can access the applet to read a status of executed event. The mobile host can then make a decision regarding the occurred event.

Messaging between the mobile host and the secure controller can be performed via software API messaging mechanisms. Messages can be provided to the mobile host during secure applet execution using a data manager in the secure controller. The secure controller can include a mailbox and a shared protected memory for providing APU method calls. The API messaging mechanism between mobile Host and TD Java Card OS can include a shared memory, named Mail-Box, which can be accessed by the mobile host at any time. The API can include a GetAppletStatus command for retrieving event notifications. The GetAppletStatus can return a response when either a timeout expired or value of the execution status changes.

In one arrangement, the completion of data transaction can be based on receiving a Transaction Acknowledge TACK command. In this arrangement, upon receiving a last command and data from the mobile host, the NFC Reader sends a Transaction Acknowledge TACK command to the mobile host, which confirms a receiving of a whole packet of data from the mobile host. Upon receiving TACK with confirmation, a secure application on the mobile host set up a signaling of the TCF value in the ESR. Moreover, an INFO command can be sent with the TACK command to provide additional data specific to the secure contactless transaction.

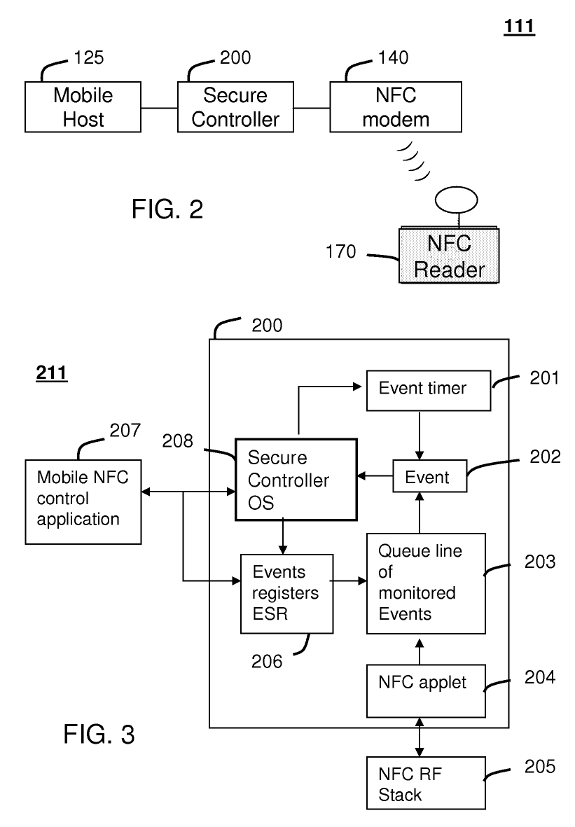

Referring to FIG. 2, a block diagram for a NFC/SIM contactless transaction system 111 is shown. The system 111 can include a Near Field Communication (NFC) modem 140 for communicating transaction events of a secure contactless transaction with a NFC reader 170, a secure controller (SM) 200 communicatively coupled to the NCF modem 140 for reliable monitoring of secure applet events associated with the transaction events, and a mobile host 125 communicatively coupled to the SM 200 for receiving event notifications associated with the state transitions. As an example, a state transition can be a request to make a payment, enable a payment, or cancel a payment. The secure controller can monitor the state transitions and send event notifications to the mobile host 125. The mobile host 125 may be an application processor or any other processor and can present a user interface to display the event notifications. As one example, an applet can reside and execute in the secure controller 200 and communicate with the NFC reader 170 via the NFC modem 140. The NFC modem 140 is essentially an RF front-end passing signals between the terminal 170 and NFC-SM 130. The applet can implement a Java messaging Application Programming Interface (API) for conveying data between the NFC Reader 170 and the mobile host 125.

In one arrangement, the mobile host 125, secure controller 200, and NFC modem 140 may be integrated on a mobile device such as a cell phone. The mobile device may also be a portable music player, a personal digital assistant, a mobile data storage unit, a personal security device or any other suitable electronic or communication device. The mobile host 125 can be an application processor that exposes a user interface to a user of the mobile device, or any other processor. The user interface can present event notification associated with a secure contactless transaction. Notably, the mobile host 125 has access to the mobile device's computing and user interface resources, such as the display, audio features, memory and processor. The mobile host 125 can provide information through the user interface to expose the user to events associated with the secure contactless transaction. As one example, the NFC/SIM contactless transaction system 111 can conduct financial transactions which can include reading credit card information from a secure module on the mobile device.

During processing of a secure contactless transaction, a message can be displayed to the user, such as a name of the financial institution, or credit card company, conducting the transaction. As another example, a list of user transactions can be presented through the user interface. The list can include historical transactions performed by the user with dates, time, location, and merchant's name. In such regard, the mobile host 125 can maintain record of a secure transaction history and keep log of user activities. As another example, the mobile host 125 can display a logo of a credit card issuer used during the secure contactless transaction.

Contactless applications can run on the mobile host 125 and receive event notifications from the API exposed by the secure controller 200. The secure controller 200 can inform applications on the mobile host 125 of events or status during the secure contactless transactions. In one arrangement, the secure controller 200 can expose an Applications Programming Interface (API) which allows applications to access a status of the events. In particular, the secure controller 200 provides a software and hardware implementation for exposing the API. The hardware consists of a data manager having a mailbox and a secured protected memory. The mailbox can include an events status register and data registers for identifying an occurrence of events and for storing event information, respectively. For example, an application can register for notification events from the mobile host 125 through the secure controller 200. The secure controller 200 can inform the mobile host 125 of transaction events, which can in turn be presented to a listener implementing the API. As an example, the NFC/SIM contactless transaction system 111 can be used for applications such as ticketing, control card access, loyalty programs, that can be hosted by contactless applications on the mobile device.

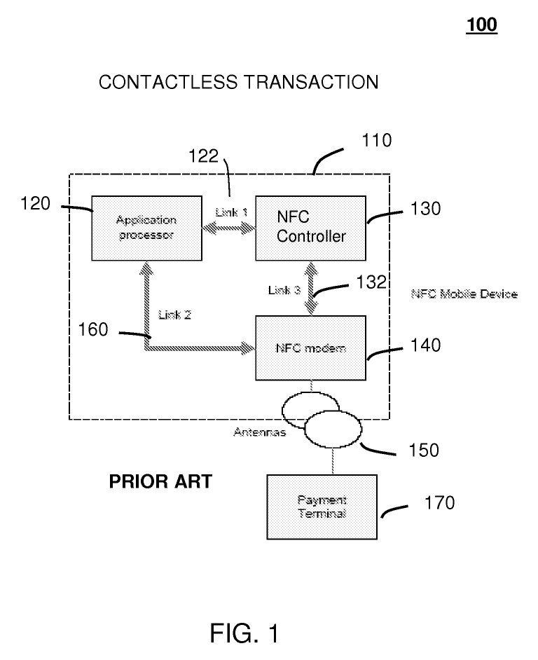

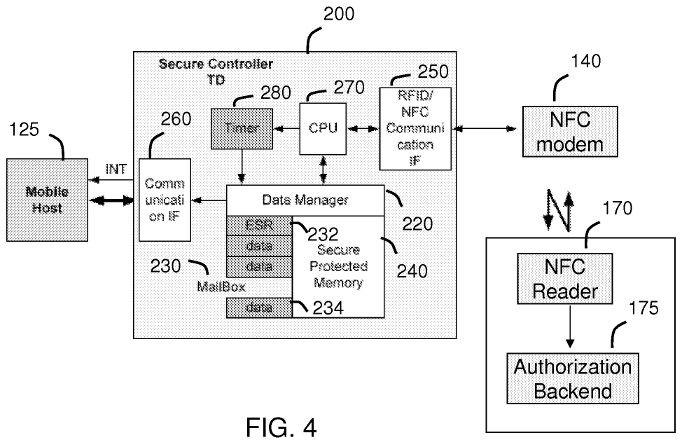

Referring to FIG. 3, the secure controller 200 is shown in greater detail. As one example, the secure controller 200 can provide reliable monitoring of secure applet events based on applet state transitions, caused by events execution. The secure controller 200 can include a mobile NFC control application which runs on the mobile host 125 of FIG. 1. Mobile host 125 has access to secure controller via an API in order to start running secure applets 204 and setting up events into ESR registers 206 based on an event timer 201, which has to be monitored by secure controller 208. Secure controller OS 208 (or monitor program) periodically monitors applet execution events from Queue line of events 203. The NFC applet can also directly communicate with the NFC modem 140 (See FIG. 1) using the NFC RF stack 205.

The secure NFC applet 204 can notify the mobile NFC control application 207 upon an event occurrence in the NFC RF stack 205 by the messaging API, which includes supported hardware and software structure. In one aspect, a main secure applet events 202, such as RFID data transaction completion, might require additional Transaction Acknowledge TACK command from NFC reader 170 to mobile, which confirms the receiving whole packet of data from mobile through RF link. That is, the NFC reader 170 (See FIG. 2) can send a TACK to the NFC applet 204 to indicate that data has been successfully read or processed.

Briefly, the mobile host 125 can send an event identification number of an event 202 to be monitored into the Secure Element ESR register 206. Upon the specific NFC secure applet 204 execution, the applet 204 can send the occurred events to an operating system (OS). This occurred events can be placed in the Queue line 203, which can be a designated operating system register (OS). The OS of the secure controller 200 can periodically monitor occurred events 202. Upon sensing the required event 202, based on ESR request, into queue line 203, OS can put the results of event 202 into ESR 206 back and sends message to Mobile via communication link and API. The link between mobile and OS might be done based on mobile's program monitoring or interrupts, sending by HW communication link of controller. In one aspect, mobile can access any time ESR in order to read events due to mail-box structure into protected secure controller memory and access even when secure NFC application still running further.

In such regard, the secure controller 200 provides secure RFID/NFC contactless applications monitoring based on events state transition. In one configuration, a shared memory Mailbox is provided between the host 125 and a secure controller events status register ESR 206. The ESR can be created in a protected secure area that is accessible by both secure OS and the mobile host 125. The mailbox can include additional registers data. The secure controller 200 can include the OS Queue line 203 of applets 204 monitored events 202.

Referring to FIG. 4, a more detailed block diagram of the secure controller for the NFC/RFID secure contactless transaction system of FIG. 1 is shown. The components of the secure controller 200 can be implemented in software by a processor such as a microprocessor or a digital signal processor (DSP) as is known in the art, or in hardware such as an ASIC or FPGA as is known in the art. The secure controller 200, can include a RFID/NFC communication interface 250 to the NFC modem for sending and receiving transaction events, a data manager 220 operatively coupled to the RFID/NFC communication interface 250 for handling event notifications, and a communication interface (CIF) 260 operatively coupled to the mobile host 125 for sending messages to the mobile host regarding event notifications. The secure controller 200 can also include a processor 270 communicatively coupled to the RFID/NFC CIF 250 for coordinating secure contactless events, and a timer 280 communicatively coupled to the processor 250 for identifying transaction event times.

The data manager 220 can include a secure protected memory 240 for storing data and transaction events between the NFC modem 140 and the NFC reader 170, a mailbox 230 for retrieving the data and transaction events and providing event notifications to the CIF. The mailbox 230 can include an events status register (ERB) 232 for specifying a number of transaction events and a status of the events, and at least one data register 234 indexed by the ESR for identifying a transaction event in the secure protected memory. In one arrangement, the data manager 220 can set up a Transaction Complete Flag (TCF) in the ESR to indicate a completion of a secure contactless transaction.

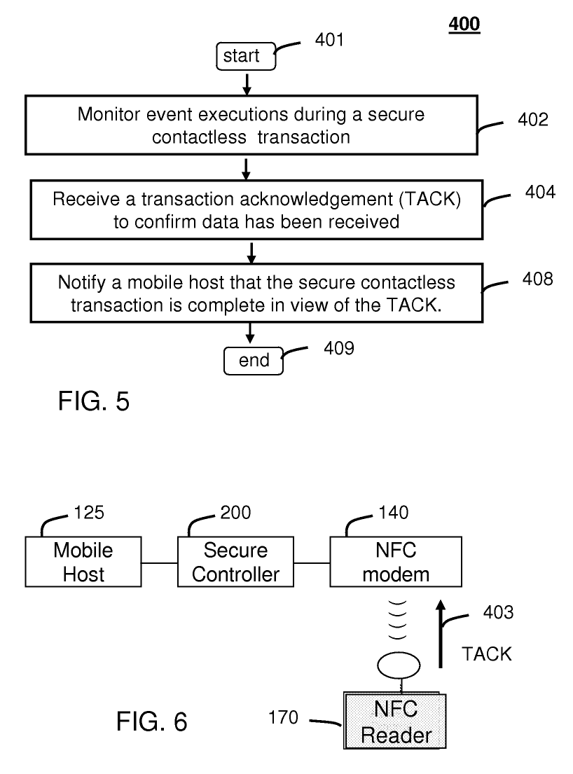

Referring to FIG. 5, a method 400 for determining a status of secure contactless transaction is shown. Briefly, the method 400 can determine a status of a secure contactless transaction upon receiving a transaction acknowledgement (TACK). A NFC reader can generate the TACK to indicate that all data associated with a secure contactless transaction has been received. The method 400 can be practiced with more or less than the number of steps shown. To describe the method 400, reference will be made to FIG. 4 although it is understood that the method 400 can be implemented in any other manner using other suitable components. In addition, the method 400 can contain a greater or a fewer number of steps than those shown in FIG. 5.

At step 401, the method 400 can start. At step 402, event executions can be monitored during a secure contactless transaction. Event executions are transactions between the NFC modem 140 and the NFC reader 170. An event execution can the communicating of a transaction event from the NFC modem 140 to the NFC reader 170. A transaction event can be a change of RF signals which causes applet state transitions. Monitoring event execution can be accomplished by monitoring applet state transitions caused by event execution. It should be noted, that the actual events between the NFC modem 140 and the NFC reader 170 cannot be reliably measured, due to security and tamper proofing. Accordingly, the secure controller 200 monitors the state transitions that are associated with the events execution. In such regard, the secure controller 200 can monitor event execution by evaluating applet state transitions. For example, a state transition may identify a request to make a payment, confirm a payment, or cancel a payment.

At step 404, a transaction acknowledgement (TACK) can be sent to confirm a receipt of data at the NFC reader. For example, referring to FIG. 6, the payment terminal (e.g. the NFC reader 170) can send a TACK 403 upon completing the contactless transaction. The payment terminal can also send a TACK 403 to the NFC modem to confirm a receipt of data associated with the secure contactless transaction.

At step 406, the TACK can be received at the NFC modem to confirm the NFC reader received the data. The NFC modem can inform the secure controller that the TACK has been received. In particular, referring to FIG. 4, the secure controller 200 can receive notification of the TACK through the RFID/NFC CIF 250 from the NFC modem 140. Upon receiving the TACK, the secure controller can set up the data into mailbox 230 for notifying the mobile host 125. Recall, a TCF flag can be set in the ESR 232 to provide an interrupt mechanism to the host to inform the host of events. Similarly, the data manager 220 can set up a flag in the mailbox 230 to signal the mobile host 125 of an event. Moreover, the data manager can expose the flag through an API running on the mobile host 125.

At step 408, a mobile host can be notified that the secure contactless transaction has been completed in view of the TACK. The notification allows the mobile host to display information associated with the secure contactless transaction as previously discussed. For example, the mobile host can display logo or merchant information to the user during the transaction. Notably, the TACK provides a confirmation that the NFC reader has received all the information necessary to complete a transaction, or that the transaction has been completed. This confirmation can be provided to the user through the user interface to inform the user of the completed transaction status.

Referring to FIG. 4, in one arrangement, the mobile host 125 can be notified via an interrupt routine when the TCF flag is written in the ESR 232. In this case, the mobile host 125 can handle the interrupt and retrieve any data associated with the contactless transaction stored by the data manager 220. In another arrangement, if the NFC reader 170 has not received the complete data package, the secure controller 200 would not receive the TACK. The timer 280 triggers an internal Timeout Counter upon the start of a secure contactless transaction. The Timeout Counter can be disabled upon receiving TACK and setting the TCF. In case of a failure of the transaction, the timer 280 generates the timeout and sets up TCF NOT_COMPLETE bits status into the ESR 232 register.

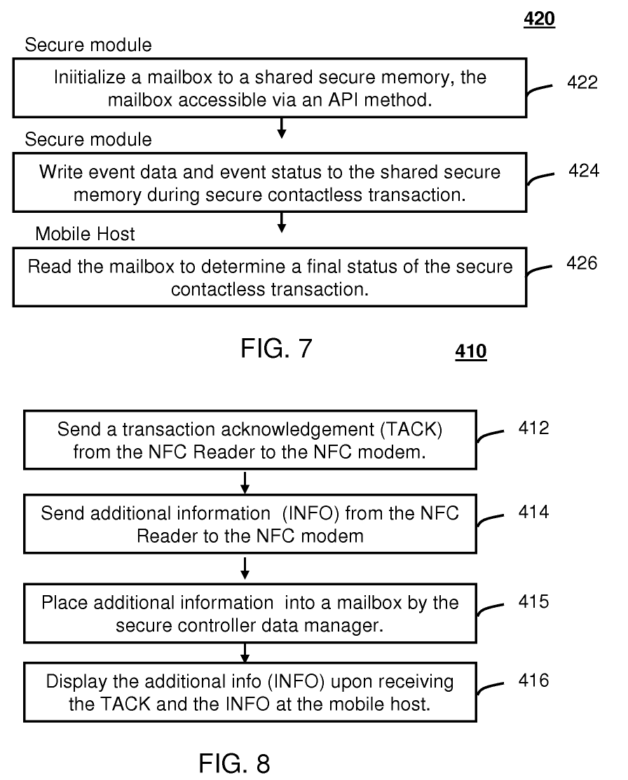

Referring to FIG. 7, one exemplary implementation 420 for processing the transaction acknowledgement (TACK) is shown. The implementation 420 can provide event notification through an Applications Programming Interface (API). It should be noted that the implementation 420 provides an underlying hardware and software structure for exposing an API.

At step 422 the secure controller can initialize a shared memory mail-box, which can be accessible from the mobile host 125 via API method through the CIF 260 and data manager of secure controller

At step 424, during the course of the secure contactless transaction, the secure controller can write event data and event status to the shared secure memory during secure contactless transaction. For example, referring to FIG. 4, the data manager 220 can store data received from the processor 270 during the state transitions. The data can be stored in the secure protected memory 240 which can be accessed by registers 234 in the mailbox 230. Moreover, the API can expose the data through API utility functions or methods.

At step 426, the mobile host can read the mailbox 230 to determine a final status of the secure contactless transaction. The mailbox 230 can include status and event notifications concerning the secure contactless transactions. For example, referring to FIG. 4, the mobile host 125 can retrieve data from the secure protected memory 240 through the data manager 220. The data can be provided to any applications running on top of the mobile host 125. For example, a payment application can inform the user of a users credit, current balance, outstanding payments, or any other information related to the secure contactless transaction.

In practice, the data manager 220 can register the mobile host 125, or any objects of an application running on the mobile host 125, as event listeners using an interrupt. The interrupt can be generated when the ESR 232 register is written with a TCF. For example, upon receiving a TACK 403, the data manager 220 can write the TCF to the ESR 232. The interrupt allows the data manager 220 to effectively inform any listeners of any processed events. That is, the interrupt signals any applications on the mobile host 125 to handle the interrupt. The applications can then request the mobile host 125 to access the shared protected memory 240 of the data manager 220 in response to the interrupt. Notably, the correspondence of events from the data manager 220, through the CIF 260, to the mobile host 125 are hidden from the application on the mobile host 125. For example, an application on the mobile host can call methods or functions to retrieve the event status and data without knowledge of the underlying processes. In such regard, the secure controller 200 provides the underlying hardware and software that allows an application, such as an applet, to receive status and event notification.

Referring to FIG. 8, an extension method 410 to the method 400 for identifying a completion of secure contactless transaction is shown. Briefly, the extension method 410 allows for the mobile host 125 to display additional information associated with the secure contactless transaction.

At step 412, a transaction acknowledgement (TACK) can be sent from the NFC Reader to the NFC modem. The TACK may identify a completion of a transaction or a completion of one stage of a transaction. For example, a secure contactless transaction may involve many stages, such as payment, authorization, and purchase. The TACK can identify that one stage has been successfully completed.

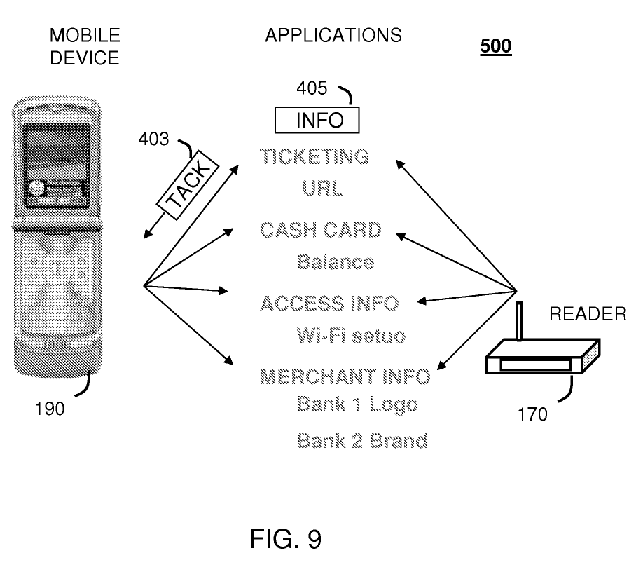

At step 414, additional information (INFO) can be sent with the TACK from the NFC Reader to the NFC modem. For example, the additional information can include data associated with the secure contactless transaction, such as account balance, authorized users, merchant information, logo, credit card issuer information, advertisements, or any other media. Referring to FIG. 9, a depiction of sending a transaction acknowledgement (ACK) and an INFO message is shown. Notably, the NFC reader 170 can send the ACK and INFO together to the mobile host 125. The mobile host 125 may include a smart card 113 for processing the ACK and the INFO.

At step 415, information associated with the contactless data transaction can be placed into a mailbox by the secure controller data manager 220 and identified by the ESR data registers 232. Mobile host should read at first this information.

At step 416, the additional info (INFO) can be displayed upon receiving the TACK and the INFO at the mobile host. For example, referring to FIG. 4, the mobile host 125 can present the information to a user interface that can be presented to a user. The mobile host 125 can be a processor in a mobile device 190, such as a cell phone, as shown in FIG. 9. A user interface of the mobile device 190 can present the additional information 405. The additional information 405 may be related to application ticketing applications, Universal Resource Locator (URL) applications, cash card applications, access information applications, or merchant information, but is not herein limited to these.

In one example, the additional information 405 can include wi-fi set up information that automatically launches an application. For example, the mobile host 125 can present a display that the user is entering a wi-fi zone and has an option of automatically connected. If the user elects to receive coverage, a wi-fi router connected to the NFC reader 170 can send set up information that can be automatically launched to allow the user to connect to the wi-fi network.

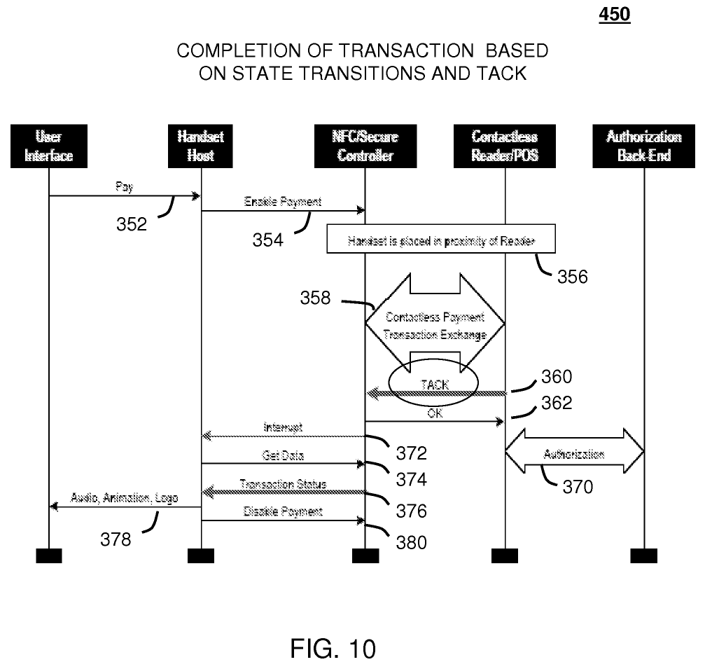

Referring to FIG. 10, a flowchart 450 for NFC/RFID contactless transaction based on state transitions and a TACK command is shown. Briefly, the flowchart 450 includes the Transaction Acknowledgement (TACK) to indicate a completion of at least one stage of a secure contactless transaction. The flowchart 450 identifies the commands and transactions associated with a NFC/RFID contactless payment.

At step 352, a user can initiate a secure contactless transaction. For example, the mobile host 125 can expose a user interface 125 which allows the user to perform a contactless payment. At step 354, the mobile host 125 can send an enable payment command to the secure controller 200. At step 356, the secure controller 200 can detect that the user has placed the handset in front of the NFC reader 170. At step 358, the secure controller 200 and the NFC reader 170 can exchange transactions. The transactions can include the exchange of credit card information, account information, or any other information associated with the transaction for making a payment. In one arrangement, at step 370, the NFC reader 170 can authenticate the payment.

During the exchange, the secure controller 200 can monitor state transitions between the NFC modem 140 and the NFC reader 170. The secure controller 200 can determine when a command is sent to the NFC reader 170. At this time, the secure controller 200 can set the TCF in the ESR 232 of the mailbox 230. At step 360, a TACK can be sent from the NFC reader 170 to the secure controller 220. The TACK command confirms a receiving of a whole packet of data from the secure controller 200. If the NFC reader 170 does not receive the whole packet, the SC 200 will not receive the TACK and mobile receive NOT_COMPLETE status. In practice, referring back to FIG. 4, the secure controller 200 triggers an internal Timeout Counter upon the start of contactless transaction, which is disabled upon receiving TACK and setting the TCF. In case of a failure of the transaction, the timeout occurs and sets up TCF NOT_COMPLETE bits status into the register.

The secure controller 200 provides messages to the mobile host 125 during secure applet execution. Recall in FIG. 4, the secure controller 200 includes a shared part of the memory, named the Mail-Box 230, which can be accessed by the mobile host 125 at any time. The API can includes a new GetAppletStatus command, that when received by the secure controller 200, returns a response. The response occurs when either a timeout expires on the timer 280 or a value of the execution status changes. The first event to occur will trigger the transmission of the response. The secure controller 200 can write and read to the mailbox 230, though the host application can only read the mailbox 230 contents during applets execution, and write at others times intervals. When an application of the secure controller 200 starts execution, the secure controller 200 writes a value indicating “in process” to the fixed mailbox 230 location. During the execution of the application, the host may read the mailbox 230 at any time. When the application completes execution, the secure controller 200 writes a value to the mailbox 184 that indicates a success or failure. The application then ceases execution. Since the host may read the mailbox 230 at any time, the host can eventually determine that the secure controller execution has ended. Subsequently, the host can determine the final status of the execution as a success or failure. The ability to write to the mailbox 230 is provided as a novel feature of the operating system application programming interface (API). In practice, the secure controller 200 provides for single method implementation to read and write data to the mailbox 230 through the operating system. For example, the function prototype could be SetExecutionStatus (short status). The values status=−1 could indicate that the execution was in progress. A value of status=0 would be successful completion. A value of status=1 could indicate failure. This method would be called both when the application began execution (status=−1), and again when the execution ended (status=0 -OR- 1). To acquire a change in the transaction status, the host (e.g. mobile device) that is connected to the secure controller 200 would use a GetAppletStatus command. The GetAppletStatus command would contain a timeout parameter. When received by the secure controller, The GetAppletStatus command returns a response when either the timeout expires or a value of the execution status changes.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A system for reliable monitoring of secure applet events suitable for use in a mobile device, comprising:
a Near Field Communication (NFC) modem for providing NFC communication, including transaction events, with a NFC reader;
a secure controller (SC) for secure applications execution and secure data processing, monitoring state transitions caused by the transaction events and generating a messaging mechanism via hardware, the SC communicatively coupled to the NCF modem; and
a mobile host communicatively coupled to the SC for receiving event notifications of the state transitions via an Applications Programming Interface, and presenting a user interface to display the event notifications.

2. The system of claim 1, wherein the secure controller includes:
A secure controller operating system (OS) or monitor program to manage applets execution and data processing;
a secure applet to execute secure transactions and to notify the mobile host upon event occurrences;
a timer communicatively coupled to the secure applet and the secure controller OS to generate events timeout
a queue line events communicatively coupled to the secure applet for storing applet events;
an application Programming Interface between mobile host and secure controller for messaging mechanism between mobile and secure applets; and
API commands that allow the mobile device to designate specific events to be monitored by secure controller upon secure applet execution and to receive messages from the secure controller in regards to events execution and accompanied data.

3. The system of claim 1, wherein the NFC reader sends a Transaction Acknowledgement (TACK) to the NFC modem to confirm a receipt of a complete pack of transaction data associated with an applet.

4. The system of claim 3, wherein the NFC reader further sends an INFO message with the TACK to provide additional information associated with the secure contactless transaction.

5. The system of claim 4, wherein the INFO message is a logo of a card issuer, a credit card brand, an application identifier, ticketing, cash card, access control, that is displayable on the user interface, or set-up data to automatically launch an application.

6. The system of claim 1, wherein the secure controller includes a shared protective memory at an operating system of the mobile host for supporting data event notifications between the secure controller an the mobile host.

7. The system of claim 1, wherein the secure controller includes:
a RFID/NFC communication interface to the NFC modem for communicating transaction events;
a data manager operatively coupled to the RFID/NFC communication interface for signaling transaction event occurrences and handling transaction event data; and
a communication interface (CIF) operatively coupled to the data manager for conveying messages to the mobile host in response to transaction event occurrences.

8. The system of claim 7, wherein the data manager includes:
a secure protected memory for storing data and transaction events communicated between the NFC modem and the NFC reader; and
a mailbox for retrieving the data and transaction events and providing reliable event notifications to the CIF.

9. The system of claim 6, wherein the mailbox includes:
a timer communicatively coupled to the data manager for identifying transaction event times;
an events status register (ESR) for specifying a number of transaction events and a status of the transaction events; and
at least one data register indexed by the ESR for identifying data and transaction events in the secure protected memory, wherein the data manager sets up a Transaction Complete Flag (TCF) in the ESR to indicate a completion of a secure contactless transaction.

10. A method for secure contactless transaction, comprising:
in a secure controller, monitoring state transitions of a secure applet during event execution of a secure contactless transaction; and
notifying a mobile's application operatively coupled to the secure applet of the applet state transitions upon an event occurrence by a software Applications Programming Interface messaging mechanism; and
setting up events of a secure applet, required to be monitored by mobile application, into mailbox ESR using API commands.

11. The method of claim 10, further comprising:
sending a transaction acknowledgement (TACK) from the NFC reader to the NFC modem to confirm a receipt of data at the NFC reader

12. The method of claim 10, further comprising:
receiving the TACK at the NFC modem, wherein the TACK confirms a complete receiving of the data associated with the secure contactless transaction.

13. The method of claim 12, further comprising:
receiving additional information (INFO) with the TACK; and
presenting the additional information (INFO) through a user interface.

14. The method of claim 10, further comprising:
saving additional information received during the secure contactless transaction to a secure protected memory in a mailbox; and
sending a message to mobile to inform the application that data in the mailbox is available for reading.

15. The method of claim 14, wherein the additional information is a logo of a card issuer, a credit card brand, an application identifier, ticketing information, cash card information, access control information,

16. The method of claim 10, further comprising communicating a message through an API based on an event notification timeout.

17. An electronic wallet for secure contactless transactions, comprising:
a NFC/RFID modem for providing secure contactless transaction with a NFC reader;
a secure controller communicatively coupled to the NFC/RFID modem for identifying events associated with the secure contactless transaction based on a software mechanism, and
a mobile host for receiving a status of the events from the secure controller, the mobile host presenting the status and the events through a user interface.

18. The electronic wallet of claim 17, wherein the secure controller is compatible with a smart card operating system.

19. The electronic wallet of claim 17, further comprising a NFC/RFID modem that sends a transmit acknowledgement (TACK) to confirm that data associated with completing the secure contactless transaction was received, and the mobile host displays information associated with a completion of the secure contactless transaction.

20. The electronic wallet of claim 17, wherein the secure controller includes: a RFID/NFC communication interface (CIF) to the NFC modem for sending and receiving messages;
a processor communicatively coupled to the RFID/NFC CIF for coordinating secure contactless events;
a timer communicatively coupled to the processor for identifying transaction event times;
a data manager for processing transaction events, the data manage comprising:
a secure protected memory for sharing data associated with the transaction events; and
a mailbox operatively coupled to the secure protected memory, the mailbox having:
an Event Status Register that sets a Transaction Completion Flag (TCF) for completed transaction events, and
a set of data registers for accessing shared data in the secure protected memory; and
a communication interface (CIF) for sending messages to the mobile host.
